(19) United States
(12) Patent Application Publication
(10) Pub. No.: US 2025/0003759 A1
(43) Pub. Date: Jan. 2, 2025

(54) Adjusting Route Travel Time Estimates in an Electronic Map System

(71) Applicant: Mapbox, Inc., Washington, DC (US)

(72) Inventors: Ruggero Altair Tacchi, San Francisco, CA (US); David Ariel Gold, Columbia, CA (US); Angela Maria Navarro, San Francisco, CA (US); Selim Seferbekov, Minsk (BY); Dzianis Dus, Warsaw (PL)

(21) Appl. No.: 18/216,350

(22) Filed: Jun. 29, 2023

(51) Int. Cl. G01C 21/34; G01C 21/00

(52) U.S. Cl. CPC G01C 21/3492; G01C 21/3885

(57) ABSTRACT

A method for estimating route traversal times for a particular route makes a first traversal time estimate for the route using estimated traversal times for the individual road segments along the route. However, since this estimate fails to take into account other factors (e.g., weather conditions, vehicle type, time of day, etc.), the method adjusts the first estimate using an adjustment model trained using data on known completed trips. The data include data of the associated routes, including estimated trip times, actual trip times, and values of a set of the other factors.

### FIELD OF ART

The description relates to the field of electronic map systems, and more particularly to estimation of times required to traverse particular routes.

### BACKGROUND

Digital electronic maps are widely used today for navigation, ride sharing, and video games, among other uses. While stand-alone map applications often include many of these functionalities, other applications can make use of electronic maps by calling a map server through an Application Programming Interface (API) on computing devices.

Among the functionality enabled by digital electronic maps is the ability to determine a route from one point to another (e.g., from a user's current location to a desired destination). Map systems can additionally estimate the time required to traverse a particular route from its origin to its destination. However, many conventional route time predictors make the estimations based purely on the individual segments of the route itself, without taking into account additional relevant factors that influence the time. Thus, such predictors would predict the same travel time between two points for (say) an 18-wheel trailer delivery vehicle during snowy weather conditions as it would for a sports car during mild weather. Such an approach fails to account for the variations in time required to traverse a given route due to other factors.

### SUMMARY

A method for estimating route traversal times for a particular route in an electronic map system makes a first traversal time estimate for the route using estimated traversal times for the individual road segments along the route. However, since this estimate fails to take into account other factors (e.g., weather conditions, vehicle type, time of day, etc.), the method adjusts the first estimate using an adjustment model trained using data on known completed trips. The data include data of the associated routes, including estimated trip times, actual trip times, and values of a set of the other factors.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 illustrates an example computer environment in which the techniques described may be practiced, according to one embodiment.

FIG. 2 illustrates a computer system upon which an embodiment may be implemented, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

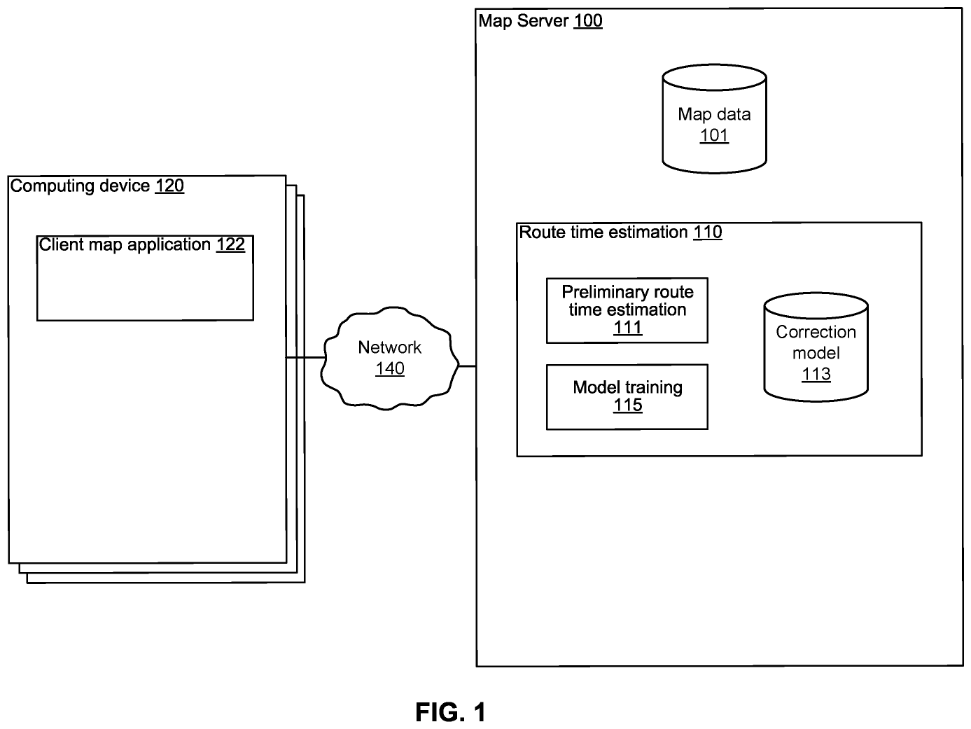

FIG. 1 illustrates an example computer environment in which the techniques described may be practiced, according to one embodiment.

A computing device 120 has a client map application 122 that communicates with a map server 100 to obtain map information from the server. The map server 100 provides the requested information to the computing device 120, which uses that information (e.g., to provide routing information to a user of the device). The various components of FIG. 1 are now described in more detail.

The computing device 120 has a client map application 122 that uses map data from the map server 100, e.g., for displaying maps, or for providing navigation instructions. For example, the client map application 122 can query the map server 100 for map data related to an origin location and a destination location, such as data on various routes between those points.

The computing devices 120 may be of various types, such as smart phones, laptop computers, desktop computers, computing devices integrated into a vehicle (e.g., navigation systems), or the like. The different computing devices 120 may have different relationships with the map server 100, depending on their types. For example, a desktop computer would typically be stationary and located within a home, and so would not provide the map server 100 with object detection or telemetry data, whereas (in contrast) a device located within a vehicle—such as a smart phone or on vehicle navigation system—could provide such information to the map server.

The client map application 122 may additionally include modules for collecting and computing information for the generation and/or enhancement of maps. For example, computing devices 120 that are mobile (e.g., can travel within a vehicle) and have hardware such as cameras, geolocation units (e.g., GPS), and sensors such as accelerometers and the like can compute information useful for the map server 100.

The map server 100 has map data 101 storing information on map objects (that is, distinct objects that have significance in a map context, such as edges of a road, road line dividers, intersections, street lights, street signs, bridges, buildings, rivers, and the like), as well as related information about those objects, such as their types and locations. Road segments are one type of map object stored in the map data 101, representing a discrete portion of a longer road. Road segments may have additional data associated with them, such as speed information (e.g., posted legal speed limits, or average speeds), traffic control lights, and the like, which are pertinent to determining how long it will take to traverse the associated segment. (Traversal times may also be precalculated and stored for the segments.)

The map server 100 additionally has a route time estimation module 110 that estimates the time that it will take for a particular trip to traverse a given route. (A particular trip for a given route has a number of associated factors that influence the time required to traverse the route, such as the particular vehicle being used, the particular time of day of the trip, the particular weather conditions, the particular traffic conditions, etc.) The route time estimation module 110 has a preliminary route time estimation module 111 that estimates the amounts of time that it will take to traverse the various road segments making up a particular route and computes its overall route traversal estimate based on the estimates for the constituent road segments. In addition to the road segment time estimates, other components may be factored into the overall route traversal estimate, such as traversal times of any intersections along the route (where the traversal time for an intersection is determined based on its properties, such as the presence of stop lights or stop signs, turn angles, etc.), times for making turns, etc. All of these estimate components can then be added together, or otherwise combined, into the overall route traversal estimate. In some embodiments, the traversal time estimate for a given road segment is based on the length of the segment and the speed associated with the segment.

Because the preliminary route time estimation module 111 makes its estimates based only on information that is specific to the route—that is, the route's constituent road segments, and not on extrinsic factors that influence travel time—the route time estimation module 110 additionally has a correction model 113 that adjusts the time estimate for the route taken as a whole. The correction model 113 takes, as input, the route, the travel time estimated by the preliminary route time estimation module 111, and other factors such as: time information (e.g., day of the year, day of the week, holiday status, and/or time of the day), weather information (e.g., temperature, and/or presence of rain or snow), traffic information, and/or driver information (e.g., driver prior trips). The factors may also include other information specific to the route, such as the type(s) of road along the route. Some of the factors may be evaluated at multiple points, such as by using the road segment traversal time estimates to predict when during the trip the vehicle will arrive at particular road segments and determining factor values for those predicted times (e.g., obtaining weather estimates for individual segments based on the times predicted for arrival at those segments).

Based on these additional factors, the correction model 113 adjusts the preliminary estimate of the travel time. For example, in some embodiments the correction model outputs a single scalar value representing a multiplier by which to multiply the preliminary time estimate for the route. (For instance, if the preliminary estimate were that a particular route would take 90 minutes to traverse, and the correction model 113 output a multiplier of 0.9 given factors such as that the vehicle in question is a sports car, the weather is mild, and the day is a weekend, then the correction model 113 would provide a final estimate of 90*0.9=81 minutes for the route.) In some embodiments, the correction model 113 uses linear regression to model the relationship of the final time estimate (the variable y) in terms of the above-described factors and the preliminary time estimate (the various variables xᵢ). In other embodiments, the training algorithm is one of non-parametric regression, deep neural networks (e.g., feed-forward, convolutional, recurrent, transformer-based, or graph neural network-based), or gradient-boosting (such as gradient-boosted decision trees).

Although the above describes the preliminary route time estimation module 111 computing an initial route time estimate, and the correction model 113 adjusting that estimate, the route travel time estimate can be computed differently in other embodiments. For example, in some embodiments the correction model 113 is used to obtain a multiplier for the entire route, before the preliminary route time estimation module 111 computes an estimate. In other embodiments, the correction model 113 corrects individual segments, rather than the route as a whole, and provides the individual-corrected segments to a routing algorithm that sums the model-predicted segment durations.

In some embodiments, the route time estimation module 110 additionally has a model training module 115 for training the correction model 113 (as opposed to obtaining the model from a different system). In these embodiments, the model training module 115 takes information about prior trips that traversed associated routes as ground truth input for training the correction model 113. The inputs for each route are the same variables input to the correction model 113 for a given trip route (e.g., the time of day, weather conditions, etc.), plus the actual route traversal time (which is known, since the trip has already occurred). The training module 115 takes the variable values for these prior trips as input, and produces the correction model 113 (e.g., the parameters for a linear regression model) as output. The correction model 113 thus models the relationship between predictor variables (the variables related to the route) and the response (the actual route traversal time).

The map server 100 may be any computing device, including but not limited to: servers, racks, work stations, personal computers, general purpose computers, laptops, Internet appliances, wireless devices, wired devices, multi-processor systems, mini-computers, and the like. Although FIG. 1 shows a single element, the map server 100 broadly represents one or multiple server computers, such as a server cluster, and the server computer may be located in one or more physical locations. The map server 100 also may represent one or more virtual computing instances that execute using one or more computers in a datacenter such as a virtual server farm.

The network 140 may be any suitable communications network for data transmission. In an embodiment such as that illustrated in FIG. 1, the network 140 uses standard communications technologies and/or protocols and can include the Internet. In another embodiment, the entities use custom and/or dedicated data communications technologies.

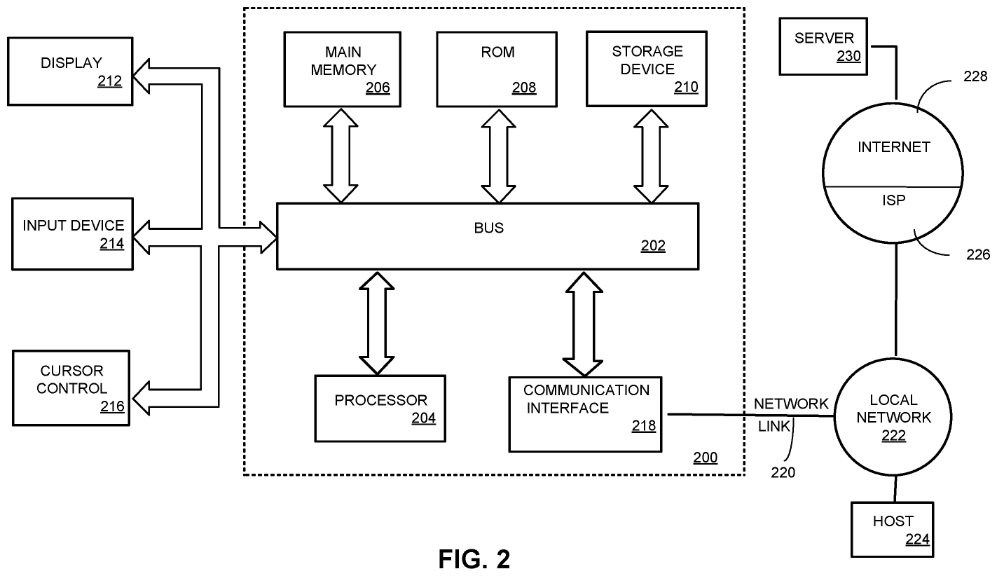

FIG. 2 is a block diagram that illustrates a computer system 200 upon which an embodiment of the invention may be implemented. Computer system 200 includes a bus 202 or other communication mechanism for communicating information, and a hardware processor 204 coupled with bus 202 for processing information. Hardware processor 204 may be, for example, a general-purpose microprocessor.

Example computer system 200 also includes a main memory 206, such as a random-access memory (RAM) or other dynamic storage device, coupled to bus 202 for storing information and instructions to be executed by processor 204. Main memory 206 also may be used for storing temporary variables or other intermediate information during execution of instructions to be executed by processor 204. Such instructions, when stored in non-transitory storage media accessible to processor 204, render computer system 200 into a special-purpose machine that is customized to perform the operations specified in the instructions.

Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a LCD screen, LED screen, or touch screen, for displaying information to a computer user. An input device 214, which may include alphanumeric and other keys, buttons, a mouse, a touchscreen, or other input elements is coupled to bus 202 for communicating information and command selections to processor 204. In some embodiments, the computer system 200 may also include a cursor control 216, such as a mouse, a trackball, or cursor direction keys for communicating direction information and command selections to processor 204 and for controlling cursor movement on display 212. The cursor control 216 typically has two degrees of freedom in two axes, a first axis (e.g., x) and a second axis (e.g., y), that allows the device to specify positions in a plane.

Computer system 200 may implement the techniques described herein using customized hard-wired logic, one or more ASICs or FPGAs, firmware and program logic which in combination with the computer system causes or programs computer system 200 to be a special-purpose machine. According to one embodiment, the techniques herein are performed by computer system 200 in response to processor 204 executing one or more sequences of one or more instructions contained in main memory 206. Such instructions may be read into main memory 206 from another storage medium, such as storage device 210. Execution of the sequences of instructions contained in main memory 206 causes processor 204 to perform the process steps described herein. In alternative embodiments, hard-wired circuitry may be used in place of or in combination with software instructions.

The term “storage media” as used herein refers to any non-transitory media that store data and instructions that cause a machine to operation in a specific fashion. Such storage media may comprise non-volatile media and volatile media. Non-volatile media includes, for example, optical or magnetic disks, such as storage device 210. Volatile media includes dynamic memory, such as main memory 206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 202. Transmission media can also take the form of acoustic, radio, or light waves, such as those generated during radio-wave and infra-red data communications, such as WI-Fl, 3G, 4G, BLUETOOTH, or wireless communications following any other wireless networking standard.

Various forms of media may be involved in carrying one or more sequences of one or more instructions to processor 204 for execution. For example, the instructions may initially be carried on a magnetic disk or solid state drive of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card, cable modem, satellite modem, or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are example forms of transmission media.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218. The received code may be executed by processor 204 as it is received, and stored in storage device 210, or other non-volatile storage for later execution.

### Additional Considerations

One possible embodiment has been described herein. Those of skill in the art will appreciate that other embodiments may likewise be practiced. First, the particular naming of the components and variables, capitalization of terms, the attributes, data structures, or any other programming or structural aspect is not mandatory or significant, and the mechanisms described may have different names, formats, or protocols. Also, the particular division of functionality between the various system components described herein is merely for purposes of example, and is not mandatory; functions performed by a single system component may instead be performed by multiple components, and functions performed by multiple components may instead be performed by a single component.

Some portions of the above description present the inventive features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects described herein include process steps and instructions in the form of an algorithm. It should be noted that the process steps and instructions could be embodied in software, firmware or hardware, and when embodied in software, could be downloaded to reside on and be operated from different platforms used by real time network operating systems.

The concepts described herein also relate to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMS, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the concepts described herein are not described with reference to any particular programming language. It is appreciated that a variety of programming languages may be used to implement the teachings as described herein, and any references to specific languages are provided for purposes of enablement and best mode.

The concepts described herein are well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure is intended to be illustrative, but not limiting, of the scope of the concepts described herein, which are set forth in the following claims.

What is claimed is:

1. A computer-implemented method for estimating route traversal time estimates on a computing device, the computer-implemented method comprising:
receiving a request from a computing device to estimate traversal time for a route on a trip;
identifying a plurality of road segments that comprise the route;
estimating a corresponding plurality of traversal times for the plurality of road segments;
computing a first traversal time estimate for the route using the plurality of estimated traversal times for the plurality of road segments;
determining values for a plurality of factors associated with the trip;
computing a second traversal time estimate for the route using an adjustment model to which the values for the plurality of factors, and the first traversal time estimate, are given as input features; and
providing the second traversal time estimate to the computing device.

2. The computer-implemented method of claim 1, wherein estimating the corresponding plurality of traversal times for the plurality of road segments uses speeds and lengths associated with the road segments in a map database.

3. The computer-implemented method of claim 1, further comprising training the adjustment model, the training comprising:
identifying data for a prior plurality of trips;
determining, for the prior plurality of trips:
values for the first plurality of factors,
estimated traversal times that are estimated using estimated traversal times for pluralities of road segments on routes corresponding to the trips;
actual travel times for the routes corresponding to the trips; and
generating the adjustment model based on the determined values for the first plurality of factors and the actual travel times.

4. The computer-implemented method of claim 3, wherein the generating uses a linear regression.

5. The computer-implemented method of claim 1, wherein the factors comprise at least one of: weather conditions associated with the trip, time of day of the trip, or type of vehicle used for the trip.

6. The computer-implemented method of claim 1, wherein the values for at least some of the factors are evaluated with respect to a plurality of locations along the route.

7. The computer-implemented method of claim 1, further comprising:
using the plurality of estimated traversal times for the plurality of road segments to predict arrival times at the plurality of road segments; and
computing values for the at least some of the factors based on the predicted arrival times.

8. A non-transitory computer-readable storage medium storing instructions that when executed by a computer processor perform actions comprising:
receiving a request from a computing device to estimate traversal time for a route on a trip;
identifying a plurality of road segments that comprise the route;
estimating a corresponding plurality of traversal times for the plurality of road segments;
computing a first traversal time estimate for the route using the plurality of estimated traversal times for the plurality of road segments;
determining values for a plurality of factors associated with the trip;
computing a second traversal time estimate for the route using an adjustment model to which the values for the plurality of factors, and the first traversal time estimate, are given as input features; and
providing the second traversal time estimate to the computing device.

9. The non-transitory computer-readable storage medium of claim 8, wherein estimating the corresponding plurality of traversal times for the plurality of road segments uses speeds and lengths associated with the road segments in a map database.

10. The non-transitory computer-readable storage medium of claim 8, the actions further comprising training the adjustment model, the training comprising:
identifying data for a prior plurality of trips;
determining, for the prior plurality of trips:
values for the first plurality of factors,
estimated traversal times that are estimated using estimated traversal times for pluralities of road segments on routes corresponding to the trips;
actual travel times for the routes corresponding to the trips; and
generating the adjustment model based on the determined values for the first plurality of factors and the actual travel times.

11. The non-transitory computer-readable storage medium of claim 10, wherein the generating uses a linear regression.

12. The non-transitory computer-readable storage medium of claim 8, wherein the factors comprise at least one of: weather conditions associated with the trip, time of day of the trip, or type of vehicle used for the trip.

13. The non-transitory computer-readable storage medium of claim 8, wherein the values for at least some of the factors are evaluated with respect to a plurality of locations along the route.

14. The non-transitory computer-readable storage medium of claim 8, the actions further comprising:
using the plurality of estimated traversal times for the plurality of road segments to predict arrival times at the plurality of road segments; and
computing values for the at least some of the factors based on the predicted arrival times.

15. A computer system comprising:
a computer processor; and
a non-transitory computer-readable storage medium storing instructions that when executed by the computer processor perform actions comprising:
receiving a request from a computing device to estimate traversal time for a route on a trip;
identifying a plurality of road segments that comprise the route;
estimating a corresponding plurality of traversal times for the plurality of road segments;
computing a first traversal time estimate for the route using the plurality of estimated traversal times for the plurality of road segments;
determining values for a plurality of factors associated with the trip;
computing a second traversal time estimate for the route using an adjustment model to which the values for the plurality of factors, and the first traversal time estimate, are given as input features; and
providing the second traversal time estimate to the computing device.

16. The computer system of claim 15, wherein estimating the corresponding plurality of traversal times for the plurality of road segments uses speeds and lengths associated with the road segments in a map database.

17. The computer system of claim 15, the actions further comprising training the adjustment model, the training comprising:
identifying data for a prior plurality of trips;
determining, for the prior plurality of trips:
values for the first plurality of factors,
estimated traversal times that are estimated using estimated traversal times for pluralities of road segments on routes corresponding to the trips;
actual travel times for the routes corresponding to the trips; and
generating the adjustment model based on the determined values for the first plurality of factors and the actual travel times.

18. The computer system of claim 17, wherein the generating uses a linear regression.

19. The computer system of claim 15, wherein the factors comprise at least one of: weather conditions associated with the trip, time of day of the trip, or type of vehicle used for the trip.

20. The computer system of claim 15, the actions further comprising:
using the plurality of estimated traversal times for the plurality of road segments to predict arrival times at the plurality of road segments; and
computing values for the at least some of the factors based on the predicted arrival times.
